(19) United States
(12) Patent Application Publication
(10) Pub. No.: US 2023/0055969 A1
(43) Pub. Date: Feb. 23, 2023

(54) DENTAL RESTORATION SCREW REMOVAL SYSTEM AND METHOD

(71) Applicant: TELCON DIAMOND LTD., Afula (IL)

(72) Inventors: Moshe BEN SIMON, TZIPORI (IL); Sawser HATUKAY, Kfar Kama (IL); Moti BARON, Kfar Vradim (IL)

(73) Assignee: TELCON DIAMOND LTD., Afula (IL)

(21) Appl. No.: 17/790,730

(22) PCT Filed: Dec. 16, 2020
(86) PCT No.: PCT/IL2020/051295

§ 371 Date: Jul. 3, 2022

Related U.S. Application Data
(60) Provisional application No. 62/978,337, filed on Feb. 19, 2020.

(51) Int. Cl. A61C 8/00; A61C 1/08; B25B 27/18

(52) U.S. Cl. CPC A61C 8/0089; A61C 1/08; B25B 27/18

(57) ABSTRACT

An aspect of some embodiments of the present invention relates to solutions for the removal of dental implant screws with stripped heads and/or dental implant screws that are difficult to remove. Optionally, the method for removing a dental implant screw comprises a method for removing the head from the shaft of a dental implant screw, for example by drilling. Once the head is removed, the abutment is optionally removed, thereby exposing the threaded screw shaft within the fixture of the implant and/or the mount for aligning the abutment. Optionally, removal of the abutment allows use the attachment to guide removal of a screw shaft.

### RELATED APPLICATION/S

This application claims the benefit of priority under 35 USC § 119(e) of U.S. Provisional Patent Application No. 62/978,337 filed Feb. 19, 2020, the contents of which are incorporated herein by reference in their entirety.

### FIELD AND BACKGROUND OF THE INVENTION

The present invention, in some embodiments thereof, relates to a method for removing a dental implant screw, and more particularly, but not exclusively, to a kit for drilling out the head of a dental implant screw.

US Patent Application Publication no. US20140113245 appears to disclose, “a drill bit for removing implant fastening screw which comprises the hole drilling drill bit 110 for axially drilling a hole in the fastening screw which broken or damaged in an implant and the screw lifting drill bit 130 for being firmly fixed the hole of the fastening screw and for lifting the fastening screw, and a guiding socket 120 which comprises the fastening portion 121 for being firmly fastened in the upper end portion of an implant in which a broken or damaged fastening screw is remained and a guiding portion 122 for guiding the hole drilling drill bit 110 to meet the central axis of the fastening screw and the central axis of the hole drilling drill bit 110.”

International Patent Application Publication no. WO2015101993 appears to disclose, “A screw retaining apparatus to be used with an internally threaded implant, the screw retaining apparatus comprising: a screw having a head; and a screw retaining abutment, comprising: a hollow body, capable of housing the screw; and a resilient block having a diameter smaller than the diameter of the head, wherein the resilient block is configured to allow permanent accommodation of the screw inside the abutment.”

Korean Utility Model no. KR20100004970U appears to disclose, “an abutment removal mechanism for a fractured artificial tooth, which is press-fitted into a fractured artificial tooth abutment and has a removal function, and a holding portion (Holding) is extended It consists of a handle sack that can be gripped. By using such a removal mechanism, it is possible to easily remove the broken abutment for artificial teeth. 1: removal mechanism, 2: fractured abutment screw, 3: fixture, 10: abutment removal mechanism, 20: holding portion, 30: handle bag portion, 40: roughness portion, 50: broken abutment Mention”

International Patent Application Publication no. WO2016140396 appears to disclose that, “The abutment removal drill according to an embodiment of the present invention comprises: a drill bit unit which removes an abutment; and a discharge part, formed on the drill bit unit, for discharging cut chips generated when drilling.”

US Patent Application Publication no. US20170209242 appears to disclose, “systems and methods for extracting a broken fragment of a dental abutment screw from a dental implant. An exemplary system comprises an extractor tool having a tubular outer body and a conductor positioned within the tubular outer body, and an applicator that receives and end of the extractor tool and also includes a heating element that converts electrical energy into heat that is conducted to the extractor tool to melt a thermoplastic adhesive in a cavity at the distal end of the extractor tool, such that the melted thermoplastic adhesive can conform to and engage with a broken fragment of a dental abutment screw within a dental implant when the adhesive cools. The extractor tool can then be rotated to unscrew the broken fragment from the dental implant.”

Chinese Patent no. CN103550003 appears to disclose, “a kind of implantation body's device and back-out instrument thereof of easy taking-up, comprise implantation body, base station and central bolt, it is characterized in that: implantation body comprises wears gum cervical region and head, and head exterior surface is provided with screw thread, the outer surface of head is also provided with at least two helical form self tapping grooves; Implantation body inside is provided with the connecting hole coaxial with implantation body, and connecting hole comprises the conical bore coaxially connected in turn, anti-rotational hole, implantation body's taking-up section and tapped blind hole; Base station comprises corona linkage section and implantation body's linkage section, and implantation body's linkage section comprises frustum and anti-rotational post; Base station inside is provided with the shoulder hole matched with central bolt; Central bolt is connected with tapped blind hole through shoulder hole, base station and implantation body is fixed as one. The advantages such as the present invention passes through to increase the implantation body with reverse thread in implantation body inside and takes out section, solves the problem remaining in the part taking-up difficulty in dental because implantation body's fracture causes, has structure simple, practical.”

Further art includes Chinese Patent Application Publication no. CN104546166, Korean Patent no. KR101098194B1, US Patent Application Publication no. US20140113245.

### SUMMARY OF THE INVENTION

According to an aspect of some embodiments of the invention, there is provided a kit for removing a head of a dental implant screw including: head removal tool configured to fit through a dental restoration and remove the head of the dental implant screw.

According to some embodiments of the invention, the dental restoration includes an abutment.

According to some embodiments of the invention, the head removal tool includes a drill having a diameter greater than a shaft of an implant fixation screw and less than or equal to the head of the screw.

According to some embodiments of the invention, the head removal tool includes a drill having a diameter greater than a shaft of an implant fixation screw and less than or equal to the head of the implant fixation screw.

According to some embodiments of the invention, the drill has a diameter of between 5/2 to 3 mm.

According to some embodiments of the invention, the kit further includes a drill guide configured to connect to an attachment of a dental implant fixture.

According to some embodiments of the invention, the head removal tool is also configured to fit through a dental crown.

According to some embodiments of the invention, the kit further includes: at least one screw shaft removal drill bit.

According to some embodiments of the invention, the kit further includes at least one drill bit for drilling through a shaft of the dental implant screw.

According to an aspect of some embodiments of the invention, there is provided a method for removing a seized dental implant screw connecting an abutment to an implant fixture, including: removing a head of the screw from a shaft of the screw; releasing the abutment from the screw; and exposing an attachment of the fixture by removing the abutment.

According to some embodiments of the invention, the removing the head of the screw includes drilling into the head.

According to some embodiments of the invention, the drilling is performed using a head removal bit which is smaller than or equal to the head of the head of the screw and larger than the shaft of the screw.

According to some embodiments of the invention, the method further includes inserting a distal end of the head removal bit through a hollow of the abutment to contact the head of the screw.

According to some embodiments of the invention, the method further includes attaching the bit to a dental handpiece and using the dental handpiece for rotating the head removal bit.

According to some embodiments of the invention, a direction of the rotating is counter clockwise.

According to some embodiments of the invention, the method further includes drilling into head of the screw with the head removal bit until the connection between the head of the screw and the shaft of the screw has been severed.

According to some embodiments of the invention, the method further includes ceasing to apply force when the head removal bit has done at least one of separating the head from the shaft of the screw and drilling to a threshold depth.

According to some embodiments of the invention, the method further includes removing the head of the screw from the shaft of the screw.

According to some embodiments of the invention, the method further includes retaining the center axis of the head removal bit is substantially identical to the center axis of the shaft of the dental implant screw during the drilling.

According to some embodiments of the invention, the threshold depth includes a depth wherein a thickness of a remaining metal attaching the head to the shaft of the screw is broken by a force applied by handheld gripping tool.

According to some embodiments of the invention, the method further includes connecting a guide to an attachment of the fixture; guiding a screw shaft removal tool with the guide while the guide is connected to the attachment.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWING(S)

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a block diagram of a kit for drilling out the head of a dental implant screw, in accordance with an embodiment of the current invention;

FIG. 2 is a schematic diagram of a dental implant 200, in the art;

FIG. 3 is a flow chart illustration of a method for removing a screw head from a dental implant screw, in accordance with an embodiment of the current invention;

FIG. 4 is a schematic illustration of detaching a screw head from a screw shaft, in accordance with an embodiment of the current invention;

FIG. 5 is a schematic illustration of a dental abutment, in the art;

FIG. 6 illustrates removing a screw with a manual removal tool in accordance with an embodiment of the current invention;

FIG. 7 illustrates milling a screw head with a screw head removing tool in accordance with an embodiment of the current invention;

FIG. 8 is a schematic illustration of removing a shaft of an abutment retaining screw using a tweezer tool in accordance with an embodiment of the current invention;

FIG. 9 is a schematic illustration of removing a screw shaft from a fixture in accordance with an embodiment of the current invention;

FIG. 10 is a schematic illustration of a guide in accordance with an embodiment of the current invention;

FIG. 11 is a box diagram of a dental screw removal kit in accordance with an embodiment of the current invention; and

FIG. 12 is a schematic illustration of a dental screw removal kit in accordance with an embodiment of the current invention.

### DESCRIPTION OF SPECIFIC EMBODIMENTS OF THE INVENTION

The present invention, in some embodiments thereof, relates to a method for removing a dental implant screw, and more particularly, but not exclusively, to a kit for drilling out the head of a dental implant screw.

### Overview

A dental implant may include a crown (e.g. an artificial tooth and/or any other dental prosthesis [for example some prostheses e.g. a bridge may connect to multiple fixtures]). For example, an implant may comprise a fixture (sometimes referred to as an implant). The fixture may be implanted into bone underlying a tooth, an abutment removably and fixedly connected on the fixture by means of a dental implant screw, and a crown and/or artificial tooth connected to the abutment, for example connected with dental cement.

An aspect of some embodiments of the present invention relates to solutions for the removal of dental implant screws with stripped heads and/or dental implant screws that are difficult to remove, for example because they either resist rotation and/or they rotate but the threads do not push the screw up and out. Optionally, the present invention provides a kit of tools, referred to herein as a kit, which may be used in removing a dental implant screw. Optionally, the present invention provides a method for removing a dental implant screw.

Optionally, the method for removing a dental implant screw comprises a method for removing the head from the shaft of a dental implant screw, for example by drilling. Since the screw head mechanically fixes the abutment to the fixture, once the head is removed, the abutment may be removed, thereby exposing the threaded screw shaft within the fixture and/or the mount for aligning the abutment referred to herein as the attachment, that was occupied by the abutment. In this manner, embodiments of the present invention may provide access to the dental implant screw threaded shaft unimpeded by the abutment. Alternatively or additionally, removal of the abutment may allow use the attachment of the fixture to guide tools (for example a drill) that are used to remove the screw shaft. For example, a guide tool that fits to the attachment of the fixture may be used to guide a drill bit into the seized screw shaft. Optionally, the guide tool includes a handle. For example, the handle may be used to hold the guide to the attachment while removing the seized screw shaft.

Optionally, the kit comprises at least one screw head removal tool. Optionally, the screw head removal tool may include a drill bit. Optionally, the drill bit may have a diameter that is less than the diameter of the threaded shaft of a dental implant screw to be removed, and greater than or equal to a diameter of the shaft of a dental implant screw to be removed. Typically, the diameter of the drill will be greater than the shaft of the screw but less than the head of the screw. For example, this will cause the head of the screw to be released before the drill reaches the shaft of the screw and/or this will avoid drilling into the shaft of the screw prior to removal of the head of the screw and/or prior to positioning of a guide. Optionally, the drill bits may be reverse (e.g. left) threaded.

Optionally the kit may further comprise any other tools and/or equipment. For example, the kit may further comprise a plurality of screw driver tips of varying dimensions, screw extractor bits of varying dimensions, drill bits of varying dimensions, drilling guides of various dimensions and geometries appropriate for various implant systems, drill taps of various dimensions, guide handles, a torque wrench, a hand adapter, an organizer for holding all the kit components, and/or any other tools found in dental implant screw removal kits.

Optionally, the method for removing the stripped head comprises drilling and/or milling the head of the stripped screw with a screw head removal tool. Drilling or milling optionally ceases when the removal tool has cut through an outer edge of the screw head around a complete and/or partial external circumference or external border of the screw head, thereby separating the screw head from the screw threaded shaft. Optionally, the method comprises further steps, for example removing the separated screw head, removing the abutment, inserting a drill guide into the cavity of the fixture, using a guide tool to stabilize and orient the drill guide, and drilling through the drill guide into the top of the threaded shaft of the dental implant screw and/or reverse tapping the threaded shaft of the dental implant screw.

In some embodiments, a screw which connects the abutment to the fixture comprises a head and a threaded shaft. For example, the screw is inserted through a hollow passageway in the abutment, and the threaded shaft is threaded into the fixture, and the screw head, which is broader than the threaded shaft and the hollow passageway, fixes the abutment to the fixture. Optionally, the head further comprises slots and/or cavities, for example a hexagonal slot, that allow a tool to rotate the screw and tighten the screw into the fixture. In the course of time and/or dental care of the dental implant, the screw head slot may become damaged, for example the walls of the hexagonal slot may become stripped such that the tightening tool will no longer rotate the screw. Further, in the course of time and/or dental care of the dental implant, even if the screw head is undamaged, the screw shaft may resist rotation, for example if the screw shaft becomes bent and/or fuses with the surrounding bone material.

In some embodiments, removal of the damaged screw may be accomplished by various methods, including reverse drilling of the screw head, using drill tap bits designed to dig into the stripped head and thereby rotate the screw, and other methods. In some cases, for example, when a screw resists rotation sufficiently, attempts to apply sufficient force to rotate the screw head may cause the screw to break and/or become damaged and/or cause damage to the tooth, the abutment and/or the fixture. In some cases, removal of a damaged screw may be impeded by the abutment. In some embodiments, the removal of the abutment may make removal of the damaged screw faster, easier, less likely to cause pain and/or discomfort to the patient, and/or less likely to cause damage to the tooth and/or bone and/or abutment and/or fixture.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

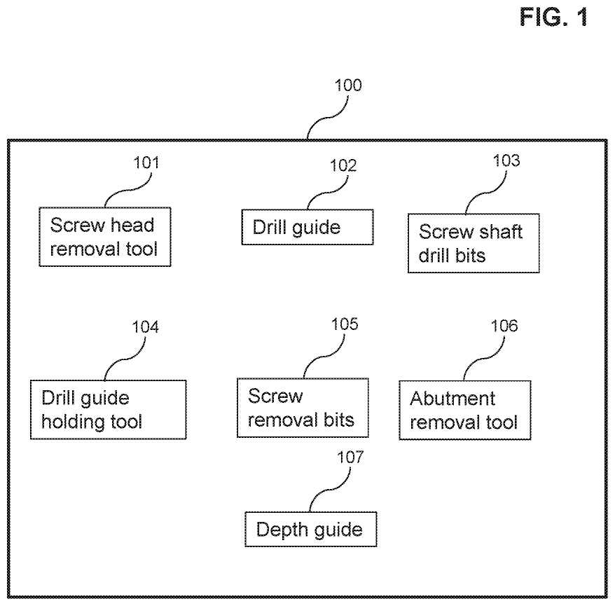

FIG. 1 is a block diagram of a kit 100 for drilling out the head of a dental implant screw, in accordance with an embodiment of the current invention. In some embodiments, kit 100 comprises at least one screw head removal tool 101. Optionally, kit 100 further comprises other dental implant screw removal tools, for example one or more drill guides 102, one or more dental implant screw shaft removal bits 103, one or more drill guide holding tools 104, one or more dental implant screw removal bits 105, one or more abutment removal tools 106, and/or one or more depth guides 107.

Optionally, the screw head removal tool 101 include be a rotatable bit insertable into a drilling tool. For example, the screw head removal tool 101 may include a drill bit, a grinding bit, a filing bit, a cutting bit, an engraving bit, and/or any other type of tool for removing, grinding, cutting, filing, and/or drilling metal.

Optionally, the dental implant screw shaft drill bits may include tap bits, drill bits, self-threading bits, and/or any other type of dental implant screw shaft removal bits.

Optionally, the screw head removal tool 101 and/or the dental implant screw shaft drill bits may be of differing diameters. For example, a particular diameter may correspond to a particular dental implant screw geometry.

Optionally, kit 100 may comprise screw head removal tools 101 with diameters that may be slightly smaller than the diameter of the screw heads, slightly larger than the diameter of the screw heads, and/or about the same diameter of the screw heads. Optionally, kit 100 may comprise a plurality of screw head removal tools 101 corresponding to a plurality of standard screw head diameters. For example, a screw head removal tool 101 may be of larger diameter, other screw head removal tools 101 of smaller diameter, and/or other screw head removal tools 101 of about the same diameter as a screw head and/or a screw shaft. For example, kit 100 may comprise screw head removal tools 101 corresponding to screw head diameters of between 0.5 mm-1 mm, 1 mm-3 mm, 3 mm-5 mm, 5 mm-10 mm and/or any other diameter screw heads used in dental implants.

In some embodiments, the diameters of standard sized dental implant screw shafts may comprise 2 mm, 3 mm, 3.5 mm, 4 mm, 4.5 mm, 5 mm, 5.5 mm, 6 mm, and/or any other diameter of a dental implant screw shaft.

In some embodiments of the present invention, kit 100 may optionally comprise screw head removal tools 101 with a diameter greater than the diameter of standard sized dental implant screw shafts and/or heads. For example, kit 100 may comprise screw head removal tools 101 ranging between 1-20 microns greater than the diameter of a standard sized dental implant screw shaft and/or head, 20-50 microns greater than the diameter of a standard sized dental implant screw shaft and/or head, 50-100 microns greater than the diameter of a standard sized dental implant screw shaft and/or head, 100-200 microns greater than the diameter of a standard sized dental implant screw shaft and/or head, 200-400 microns greater than the diameter of a standard sized dental implant screw shaft and/or head, and/or 400-1,000 microns greater than the diameter of a standard sized dental implant screw shaft and/or head.

In some embodiments of the present invention, kit 100 may optionally comprise screw head removal tools 101 with a diameter less than the diameter of standard sized dental implant screw shaft and/or head. For example, kit 100 may comprise drill screw head removal tools 101 ranging between 1-20 microns less than the diameter of a standard sized dental implant screw shaft and/or head, 20-50 microns less than the diameter of a standard sized dental implant screw shaft and/or head, 50-100 microns less than the diameter of a standard sized dental implant screw shaft and/or head, 100-200 microns less than the diameter of a standard sized dental implant screw shaft and/or head, 200-400 microns less than the diameter of a standard sized dental implant screw shaft and/or head, and/or 400-1,000 microns less than the diameter of a standard sized dental implant screw shaft and/or head.

In some embodiments of the present invention, kit 100 may comprise a one or more screw head removal tools 101 with a diameter ranging that may be approximately equal greater to the diameter of a standard size implant screw threaded shaft and/or greater than the diameter of the scree shaft. The diameter of the head removal tools is optionally less than the diameter of the standard size of implant screw head. For example, kit 100 may comprise a screw head removal tool 101 with a shaft diameter of about 4 millimeters for drilling a screw with a threaded shaft diameter of 3 millimeters and/or a screw head diameter of 5 millimeters for example, the shaft diameter of tool 101 may range between 1.0 to 2.5 mm and/or between 2.5 mm to 3.5 mm and/or between 3.5 to 5 mm.

In some embodiments of the present invention, at least one of screw head removal tools 101 may be of a design and/or geometry similar to cutting, grinding, drilling, and/or engraving drill bits designed for metal work. For example, screw head removal tools 101 may have a design and/or geometry similar to step drill bits, jewelry drilling and/or engraving bits, PCB drilling and/or engraving bits, fine metal working drill bits, subland step drill bits, router bits, jobber drill bits, aircraft extension drill bits, screw machine drill bits, taper shank drill bits, half round and spade drill bits, and/or micro drill bits.

In some embodiments of the present invention, at least one of the screw head removal tools 101 may have a design that differs from standard drilling, grinding, and/or engraving bits designed for metal. For example, the point cutting edge and/or the chisel edge of bits may have a more acute angle measured from the axis of the shaft length compared with standard bits, the point cutting edge and/or the chisel edge of bits may have a less acute angle measured from the axis of the shaft length compared with standard bits, the point cutting edge and/or the chisel edge of bits may be substantially perpendicular to the axis of the shaft length, the screw head removal tools 101 may comprise a center or starting bit, the screw head removal tools 101 cutting edges may comprise grinding surfaces, the screw head removal tools 101 spiral flutes may have more revolutions per unit of shaft length compared to standard bits, the screw head removal tools 101 spiral flutes may have fewer revolutions per unit of shaft length compared to standard bits, and/or any other variation and/or combination of variations compared to standard bits.

In some embodiments of the present invention, at least one of the screw head removal tools 101 may be composed of metals similar to standard medical metal cutting drill bits. Optionally, at least one screw head removal tool 101 and/or parts thereof may be composed of metals different from standard medical metal cutting drill bits. For example, the screw head removal tool 101 may be at least partially composed of and/or coated with titanium, diamonds, tungsten carbide, cobalt, and/or any other material.

In some embodiments of the present invention, the cutting edge of the screw head removal tools 101 may be located along the flutes of a drill bit shaft, for example in the manner of a drill bit to enlarge an existing hole, such as a reamer. Optionally, kit 100 may comprise bits of various types, for example an annular cutter, a countersink bit, and/or any other type of drilling and/or grinding and/or engraving bit.

In some embodiments of the present invention, kit 100 may comprise one or more screw head removal tools 101 that are reverse threaded, wherein the screw head removal tool 101 is rotated counter-clockwise. Optionally, kit 100 may comprise one or more screw head removal tools 101 that are forward threaded, wherein the screw head removal tool 101 is rotated counter clockwise.

In some embodiments of the present invention, the depth guide may determine a maximum depth that the screw head removal tools 101 may cut into a screw head and/or shaft.

In some embodiments of the present invention, drill guides, guide holding tools, abutment removal tools, and/or dental implant screw shaft removal bits, may comprise components of the kit 100 for removing damaged and/or broken abutment and/or dental implant screws. For example, the drill bits for removing the dental implant screw shaft may be tap bits and/or any other type of bit for removing a damaged screw, the plurality of guides may comprise a plurality of geometries that may be inserted into a plurality of geometries of holes within the fixture for inserting the abutment, guide holding tool may comprise geometries appropriate for gripping the guides, and/or the torque wrench and/or drill may comprise a connector for holding a drill bit.

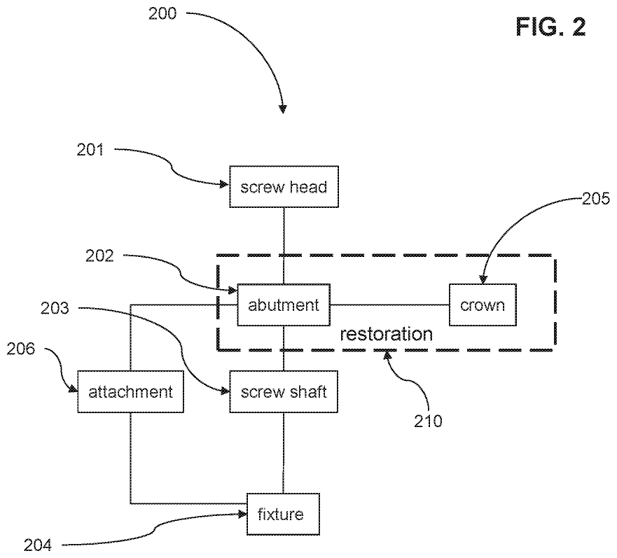

FIG. 2 is a block diagram of an exemplary dental implant system 200. Optionally a dental implant system comprises a screw including a screw head 201 and/or a screw shaft 203. The system may also include a dental restoration 210. For example, the restoration 210 may include an abutment 202 and/or a crown 205 and/or a bridge and/or an onlay and/or an inlay or the like. Optionally the abutment attaches to a fixture 204. The dental fixture 204 is optionally implanted into the jaw bone of a patient. In some embodiments, the abutment is connected to the fixture via an attachment 206 on the fixture 204. For example, the attachment may include an external hexagonal protrusion and/or an internal hexagonal indentation and/or an internal taper and/or a spline. In some embodiments, the connection between the attachment fixes that position and/or alignment between the abutment and the fixture. Optionally, the screw secures the connection between the abutment and the attachment and/or the fixture.

In some embodiments, fixture 204 is screwed into a bone, and/or abutment 202 is removably connected on fixture 204 by means of screw shaft 203 through abutment 202 and threading into fixture 204, where screw head 201 fastens abutment 202 to fixture 204 for example via attachment 206. Optionally, a crown 205 is connected to abutment 202.

In some cases, it may be desirable to replace a crown 205 and/or an abutment 202 and/or a screw. The fixture 204 is generally fixed into a bone. Optionally, in cases where the screw, abutment 202 and/or crown 205 are to be replaced, it may be desirable to reuse the same fixture. In a case where a screw seizes and/or fails, it may be desirable to remove the screw without damaging and/or loosening the fixture. In some embodiments, the current invention supplies methods and tools to remove a seized screw with reduced damage to the fixture.

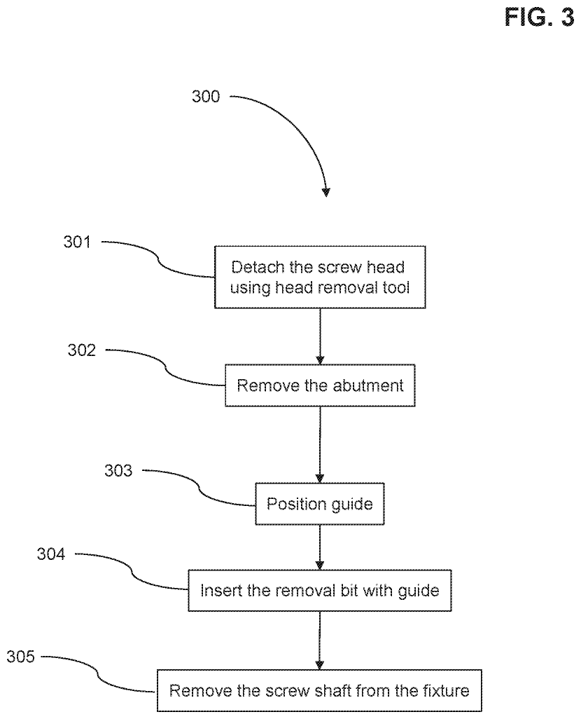

FIG. 3 is a flow chart illustration of a method 300 for removing a screw head from a dental implant screw, in accordance with an embodiment of the current invention. A dental implant screw holding an abutment to a fixture is optionally located within a cavity in the abutment. Optionally, the head of the dental implant screw fixes the abutment to the fixture.

According to an embodiment of the current invention, method 300 includes detaching 301 a screw head from a screw shaft using a screw head removal tool. For example, the screw head removal tool may be inserted into a power drill and/or hand drill and/or wrench, referred to herein as the drill. The screw head removal tool optionally comprises a proximal end which is attachable to a drill, and a distal end that may drill and/or grind and/or cut the screw head. Optionally, the drill begins rotating the screw head removal tool. Optionally, the drill rotates the screw head removal tool in a direction opposite the tightening rotational direction of the screw. Optionally, the distal cutting edge of the screw head removal tool is placed against the head of the dental implant screw. Optionally the axis of the center of a length of the screw head removal tool is substantially identical to the axis of the center of a length of the screw threaded shaft. Optionally, the axis of the screw head removal tool may vary during the drilling operation, such that the screw head removal tool cutting edge may drill laterally into the screw head.

Optionally, a force is applied by the drill onto the screw head removal tool to press onto the screw head. Optionally, the screw head removal tool drills and/or grinds and/or files and/or cuts the head of the screw. Optionally, the force is ceased when the screw head removal tool has drilled to a threshold depth.

In some embodiments of the present invention, the threshold depth may be about the height of the screw head, slightly less than the height of the dental implant screw head, or slightly more than the height of the screw head. Optionally the threshold height is determined by the drill detaching the screw head from the dental implant screw shaft. Optionally the threshold height is determined by drilling a sufficient depth into the screw head such that the screw head may be removed from the dental implant screw shaft by a force applied by a hand tool, for example a plier and/or other gripping tool that may be used to grip the screw head. For example, the threshold depth may be reached when the remaining metal connecting the dental implant screw head to the shaft is of a thickness of 1-50 microns, 50-100 microns, 100-150 microns, 150-200 microns, 200-250 microns, 250-300 microns, and/or less than 1,000 microns. Optionally, the screw head is removed after it is detached from the shaft.

In some embodiments of the present invention, the method further comprises steps for removing the dental implant screw shaft after the head has been detached. Various methods may be used for removing the screw shaft within the scope of the current invention. For example, optionally the method of the present invention may further comprise steps for removing a screw shaft where the screw head broke off from the shaft. For example, the abutment may be removed 302, and a guide may be positioned 303 to guide removal of the screw shaft. For example, the guide may be connected to the attachment of the fixture. Optionally a guide holding tool is used to position the guide and/or to hold the attachment. Optionally, a drill bit for removing the dental implant screw shaft mounted on a drill may be inserted 304 into the drill guide, pressure may be applied onto the dental implant screw shaft from the drill bit, thereby rotating the dental implant screw shaft in a direction to remove 305 the dental implant screw shaft from the fixture.

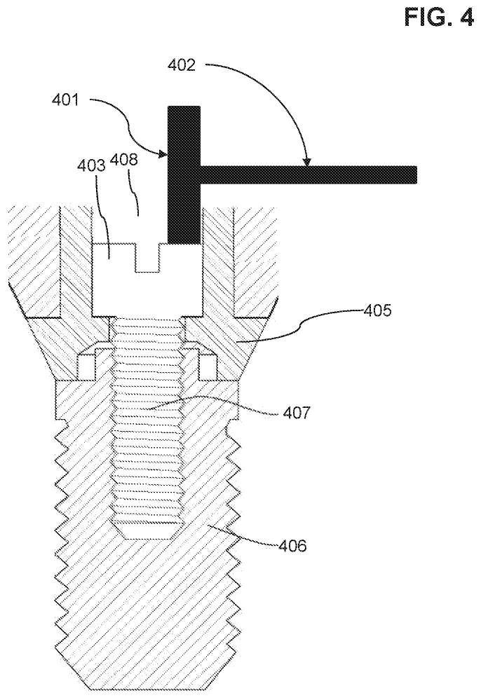

FIG. 4 is a schematic illustration of detaching a screw head from a screw shaft, in accordance with an embodiment of the current invention. Abutment 405 is secured to fixture 406 by means of screw head 403 and screw shaft 407. Optionally, screw head removal tool 401 is held by drill 402, and is pushed into a hollow 408 of the abutment to contact screw head 403. For example, a crown may be removed and/or milled down to read the abutment and/or a hole may be drilled through the crown and/or the removal tool 401 may be inserted through the hole. Optionally screw head removal tool 401 drills and/or cuts and/or files and/or grinds screw head 403.

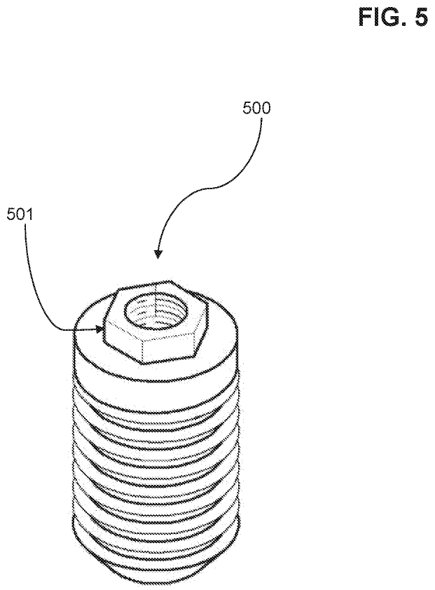

FIG. 5 is a schematic illustration of a dental fixture. Fixture 500 comprises an attachment 501 which may be used to orient and/or stabilize a drill guide with respect to the fixture 500. Optionally, attachment 501 may include an external hexagonal protrusion. Alternatively or additionally, an attachment may include an internal hexagonal indentation and/or an internal taper and/or a spline. In some embodiments, the attachment is used to fixes that position and/or alignment between the fixture and a tool for removing a screw shaft. Optionally, the attachment 501 is exposed (for example by removing an abutment and/or filing off the head of a screw holding the abutment to the fixture 500). The exposed attachment 501 may optionally be used to guide a removal tool removing the shaft of a screw (for example a drill).

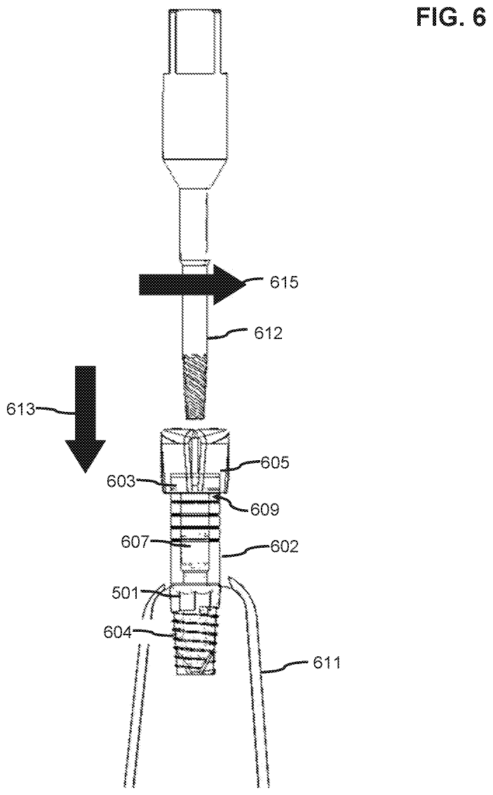

FIGS. 6-10 are schematic illustrations of steps in removing a screw 609 in accordance with an embodiment of the current invention. For example, when for some reason it is desired to remove and/or replace a crown 605, a hole may be cleared through the crown 605 exposing an abutment 602 and/or an abutment holding screw 609. In FIGS. 6-9, the abutment 602 and the crown 605 are illustrated as transparent so that the abutment screw 609 (including its head 603 and shaft 607) and the attachment 501 of the fixture 604 can be seen through the walls of the abutment 602 and the crown 605. For example, there may be an existing hole that is blocked by a filling and/or a hole may be drilled through the crown 605 and/or an existing hole may be expanded. In some cases, the screw 609 may be removed from a fixture 604 that is implanted into a bone 611 using a screw driver. After removing the screw 609, the abutment 602 and/or crown 605 may be replaced.

FIG. 6 illustrates removing screw 609 with a manual removal tool 612 in accordance with an embodiment of the current invention. In some cases, the screw 609 may get locked and/or engaged to another part of the implant system (e.g. the fixture 604 and/or the abutment 602). In some embodiments, the manual removal tool 612 is engaged to the screw 609 and/or used to twist the screw 609 and/or screw it out of the fixture 604. For example, this may be useful when the head 603 of the screw 609 has become stripped and/or a screw driver fails to lock to the head 603. Optionally, the manual tool is designed to penetrate (for example with a left hand threading) and/or lock into the screw 609 when it is pressed 613 into the screw 609 and/or rotated in a direction of rotation 615 opposite the insertion direction of screw 609.

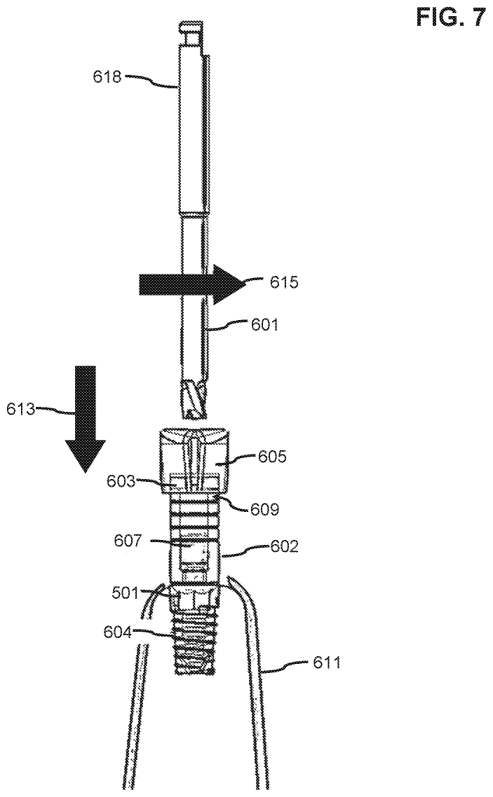

FIG. 7 illustrates milling a screw head 603 with a screw head removing tool 601 in accordance with an embodiment of the current invention. For example, milling the head 603 of the abutment retaining screw 609 may be used when the abutment 602 and/or crown 605 are retained on the fixture 604 by the abutment 602 by a stuck retaining screw that fails to come off using a screw driver and/or the manual tweezer tool 612. For example, a head drill 601 may be used to drill into the head 603 of the screw 609. For example, the head drill 601 may be thin enough to fit through a hole in the crown 605 and/or thinner than the head 603 of the screw 609. For example, the hole may have been cleared through the crown 605 and/or abutment 602. Optionally, the head drill may be wide enough that it weakens and/or destroys the link between the head 603 of the screw 609 and/or the shaft 607 thereof. For example, the head drill 601 may have a diameter that is between 50% to 75% of the diameter of the shaft 607 of the screw 609 and/or between 75% to 90% of the diameter of the shaft 607 of the screw 609 and/or between 90% to 98% of the diameter of the shaft 607 of the screw 609 and/or between 98% to 102% of the diameter of the shaft 607 of the screw 609 and/or between 102% to 110% of the diameter of the shaft 607 of the screw 609 and/or between 110% to 150% of the diameter of the shaft 607 of the screw 609 and/or between 150% to 300% of the diameter of the shaft 607 of the screw 609. Optionally, the head drill 601 may have a coupler 618 on a proximal section thereof (e.g. a D-ring coupler 618 for connecting the head drill 601 to a dental drill handpiece e.g. for rotating the head drill). Optionally, the head drill 601 is configured (e.g. the drill 601 is left threaded) for reverse rotation that may loosen the shaft of the abutment retaining screw 609 while penetrating the head 603.

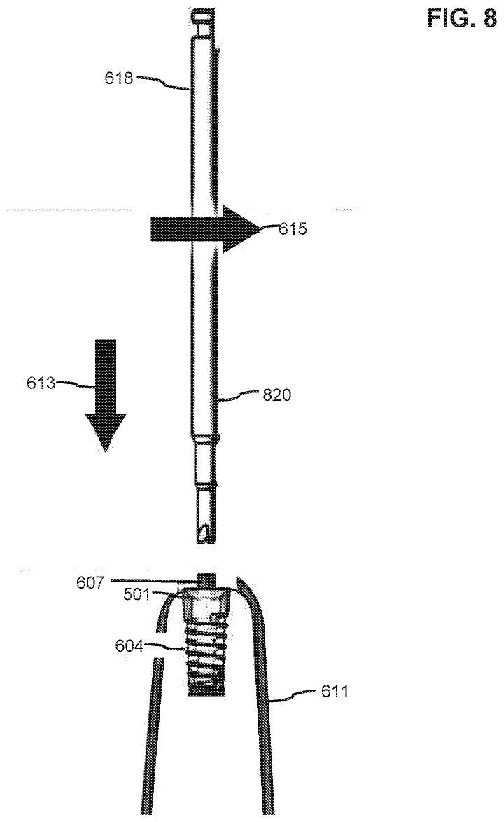

FIG. 8 is a schematic illustration of removing a left over stub of shaft 607 of an abutment retaining screw 609 using a remover tool 820 in accordance with an embodiment of the current invention. For example, a stub of a screw shaft 607 may remain in the fixture 604 after milling off the screw head 603 and/or removing the crown 605 and/or removing the abutment 602. For example, the remover tool 820 may engage the top of the shaft 607 of the abutment retaining screw 609 strongly enough to unscrew the remaining shaft.

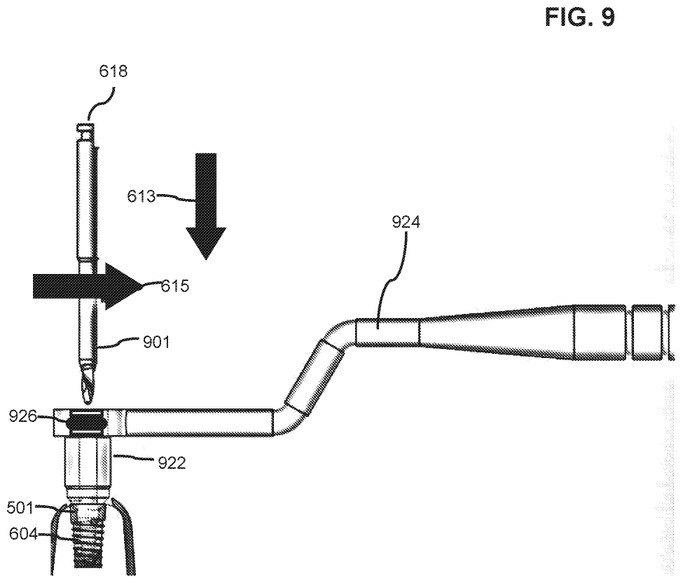

FIG. 9 is a schematic illustration of removing a screw shaft from a fixture 604 in accordance with an embodiment of the current invention. For example, an attachment 501 of the fixture 604 may be exposed (for example by removing the abutment and/or crown). A guide 922 may be positioned to guide drilling into the screw shaft. For example, the guide 922 is optionally connected to the attachment 501 of the fixture 604 and/or held using a handle 924. With the guide 922 properly positioned, the guide 922 may be used to guide a drill 901 into the shaft of the abutment retaining screw. For example, the guide may facilitate drilling into the shaft of the screw without damaging the fixture 604. For example, the diameter of the drill 901 may be less than (e.g. ranging between 25% to 50% and/or 50% to 75% and/or 75% to 90% and/or 90% to 95% and/or 95% to 99% the diameter of the abutment retaining screw shaft Optionally the drill 901 includes a coupler 618 (e.g. for coupling to a dental handpiece and/or rotating the remover. Optionally, the drill 901 is configured (e.g. the drill is left threaded) for reverse rotation 615 that may loosen the shaft of the abutment retaining screw while being pressed 613 into the screw head.

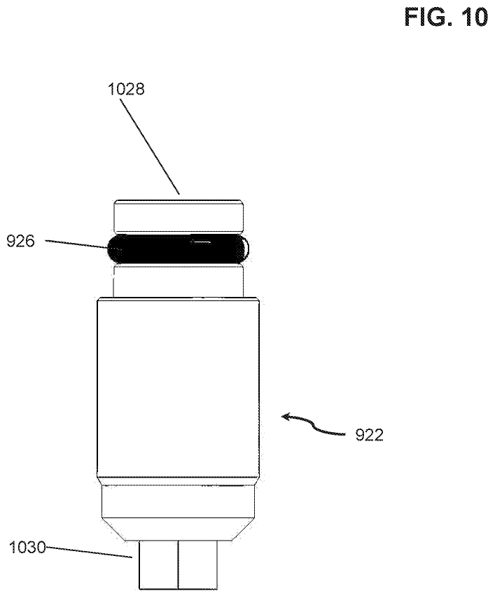

FIG. 10 is a schematic illustration of a guide 922 in accordance with an embodiment of the current invention. For example, the guide may have a fitting 1030 that fits to an attachment 501 of the fixture 604. For example, connecting the fitting 1030 to the attachment 501 may fix the position of the guide 922 with respect to the fixture 604 (note that different sleeves may have different fittings to connect to fixtures having different types of attachments, for example a protruding fixture may connect to a socket type attachment and/or a socket fixture may fit to a protruding attachment). Optionally the fitting 1030 is on a distal portion of the guide. Optionally the guide includes a grip 926. For example, the grip 926 may be on a proximal portion of the guide 922. Optionally, the grip 926 may be configured for use when grasping with a handle (e.g. handle 924 of FIG. 9). Optionally the body 1028 of the guide is hollow, for example the drill (e.g. drill 601 of FIG. 9) for the abutment screw may fit snugly to the guide 922 such the fixing the guide 922 with respect to the fixture 604 (e.g. as described above using the fitting 1030 and/or the fixture attachment 501) also fixes the direction of movement of the drill 901 into the screw and/or fixture 604.

In some embodiments, a kit for removing a stuck abutment retaining screw may include one or more of all and/or some of a tweezer, a head drill, a remover, a drill for an abutment retaining screw shaft, and/or a drill for a crown.

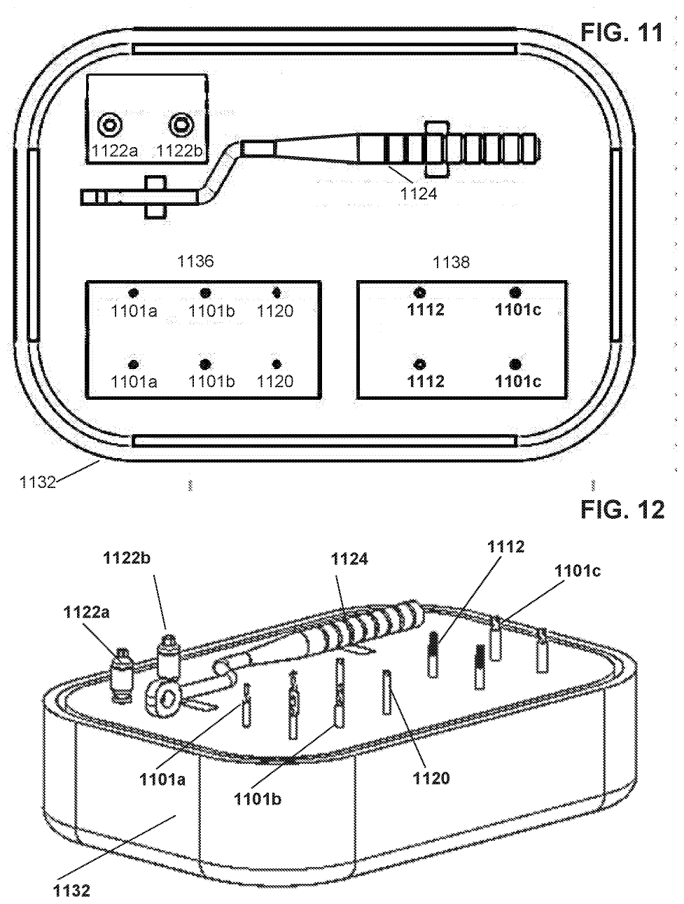

FIG. 11 is an overhead schematic of a dental screw removal kit in accordance with an embodiment of the current invention. For example, the kit may be packaged in an organizer box 1132. Optionally the kit may include:

A Guide Stabilizing Handle 1124
In some embodiments, the handle 1124 is used to keep a guide sleeve 1122a, 1122b steady during the operation.

Guide Sleeve 1122a, 1122b
In some embodiments, the guide sleeve 1122a is used to guide a drill into the screw shaft, and/or to inhibit damaging the fixture internal thread. For example, the kit may include a plurality of guide sleeves 1122a, 1122b for example with different attachments to fit different fixtures. For example, the illustrated kit includes a guide 1122a with a 2.1 mm hex attachment and a guide 1122b with a 2.4 mm hex attachment.

Screw Shaft Removal Tools 1136 may be Included, for Example, Including:

Conical Drill 1101a, 1101b for Screw Shaft Removal
In some embodiments, a conical drill 1101a, 1101b provided for extracting the screw shaft by counter clockwise rotation for example as illustrated in FIG. 9 with drill 901. Optionally different sizes may be provided for example a 3.3 mm drill 1101a and/or a 3.75 mm drill 1101b. Optionally drill bits diameters may range between 0.1 to 0.7 mm and/or between 0.7 to 2.0 mm and/or between 2.0 to 4.0 mm. There may be long and/or short drills.

Screw Removal Tools and/or Screw Head Removal Tools may be Included in the Kit, for Example Including:

Tweezer Tool 1120 for Screw Shaft Removal
In some embodiments, the tweezer 1120 tool is used to pull out the remaining screw shaft for example as illustrated in FIG. 8 with tool 820.

Manual Screw Removal Tool 1112
In some embodiments, the manual screw removal tool 1112 is used for counter clockwise manual rotation of the screw head, in order to first try pulling it out manually, for example as illustrated with tool 612 in FIG. 6.

Damaged Screw Head Retriever Drill 1101c
In some embodiments, the damaged screw head retriever drill 1101c is used to remove the screw head from its shaft while counter clockwise pulling the screw out, for example as illustrated with drill 601 in FIG. 7.

FIG. 12 is a schematic perspective illustration of a dental screw removal kit in accordance with an embodiment of the current invention.

1. Exemplar Indications for Use of a Screw Removal Kit:
Some embodiments of a dental screw removal kit may be used for the various procedures including for example:
   1. Extraction of dental screw when screw head is damaged.
   The extraction of a dental screw with damaged head may occur under various scenarios including for example:
      a. The head of the dental screw connecting the crown to the abutment is damaged.
      b. The head of the dental screw connecting the abutment to the fixture is damaged.
   2. Extraction of dental screw shaft out of the fixture after screw breakage.

Exemplary Procedure 1
1. In some embodiments (for example as illustrated in FIG. 6), the manual remover tool 1112 is inserted into the dental screw damaged head and rotated by hand counter clockwise. In some cases (for example when the screw is a bit loose), this procedure may rotate and/or released the screw. In case the screw is not released, optionally continue to next step.
2. In some embodiments, a coupler of the head drill 1101c is inserted into the chuck of a dental hand piece.
   a. Optionally the hand piece is set in reverse mode (counter clockwise).
   b. Optionally the hand piece is set to rotate the head drill at 800 RPM is the recommended revolutions. RPM may be set for example between 200 to 600 RPM and/or between 600 to 900 RPM and/or between 900 to 1200 RPM.
   In some cases, too high RPM may generate excessive heat which can deteriorate tool efficiency.
   c. In some embodiments, (for example as illustrated in FIG. 7) the hand piece and/or head drill 1101c are used to drill into the damaged screw head. Optionally the drill 1101c is maintained parallel to the dental screw. For example, drilling is stopped periodically (approx. every 20 seconds and/or between every 1 to 10 sec and/or 10 to 30 sec and/or 30 to 60 sec and/or 60 to 300 sec). Periodically the status of the screw head is checked (for example while drilling is stopped and/or between every 1 to 10 sec and/or 10 to 30 sec and/or 30 to 60 sec and/or 60 to 300 sec) and/or the drilling area is cleaned (e.g. by spraying with cleaning fluid, for example saline solution for example using a triple syringe).
   d. In some embodiments, the head of the dental screw is removed.
   Optionally the reverse rotation will also facilitate unscrewing the screw shaft.
   e. In some embodiments, the abutment is removed. For example, removal may be by hand while applying side force. Optionally removal is after drilling the screw head.
   In some embodiments, drilling may be repeated and/or continue a little more, for example if abutment is not easily taken off by hand.
3. In some embodiments, after abutment is taken off, the fixture is checked to see whether dental screw is completely removed. Optionally, if dental screw shaft remains inside the fixture, Exemplary procedure 2 may be used to remove it.

Exemplary Procedure 2
1. In some embodiments, e.g. when the dental screw shaft is extended a bit out of the fixture, the tweezer tool 1120 is optionally inserted into a dental hand piece.
   a. Optionally the dental handpiece is set in reverse mode (counter clockwise).
   In some embodiments, if the dental hand piece is not in reverse, the screw shaft may be pushed in and not out as desired.
   b. Optionally the hand piece is set to rotate the head drill at 800 RPM is the recommended revolutions. RPM may be set for example between 200 to 600 RPM and/or between 600 to 900 RPM and/or between 900 to 1200 RPM.
   c. In some embodiments, this will release the screw shaft out of the fixture for example as illustrated in FIG. 8.
2. In some embodiments, the dental screw shaft may remain inside the fixture and/or may be hidden completely inside the fixture. Optionally, the fixture attachment is checked and/or the right guide sleeve 1122a, 1122b is chosen to engage the attachment:
   a. For example, for a 3.75 mm fixture with a 2.4 mm attachment, the 2.4 hex sleeve guide 1122b may be used.
   b. For a fixture with a 3.33 mm fixture with a 2.1 hex attachment, the 2.1 Sleeve guide 1122a may be used.
   In some embodiments, choosing the right sleeve facilitates proper guiding of the drill. Wrong sleeve usage may cause damage to the fixture.
3. In some embodiments, the following procedure may be used for either the 3.3 mm fixture and/or the 3.75 mm fixture.
   a. In some embodiments, a mouth opener is used to open the mouth of the patient.
   b. In some embodiments, the drilling tool (e.g. 3.3 mm drill 1101a and/or 3.75 mm drill 1101b) is inserted into hand piece.
   c. Optionally the dental handpiece is set in reverse mode (counter clockwise).
   In some embodiments, if the dental hand piece is not in reverse, the screw shaft may be pushed in and not out as desired.
   Optionally the hand piece is set to rotate the head drill at 800 RPM is the recommended revolutions. RPM may be set for example between 200 to 600 RPM and/or between 600 to 900 RPM and/or between 900 to 1200 RPM.
   In some cases, too high RPM may generate excessive heat which can deteriorate tool efficiency.
   d. In some embodiments, a fitting of the guide 1122a, 1122b is engaged to the attachment of the fixture. Optionally, the guide 1122a, 1122b is held using the stabilizing handle 1124.
   e. In some embodiments, the drill 1101a, 1101b is inserted into the guide sleeve 1122a, 1122b for guiding and/or drilling is started in reverse mode into the screw shaft (for example as illustrated in FIG. 9). In some embodiments, the hand piece and/or head drill are used to drill into the damaged screw head. Optionally the drill 1101a, 1101b is maintained parallel to the dental screw. For example, drilling is stopped periodically (approx. every 20 seconds and/or between every 1 to 10 sec and/or 10 to 30 sec and/or 30 to 60 sec and/or 60 to 300 sec). Periodically the status of the screw head is checked (for example while drilling is stopped and/or between every 1 to 10 sec and/or 10 to 30 sec and/or 30 to 60 sec and/or 60 to 300 sec) and/or the drilling area is cleaned (e.g. by spraying with cleaning fluid, for example saline solution for example using a triple syringe). The screw shaft may gradually unscrew and/or may be released from the fixture thread.
   f. In some embodiments, the screw shaft will climb up and/or be released completely.
   g. In some embodiments, the tweezer tool 1120 may be used to facilitate a final release of the screw shaft.
   h. Optionally the dental handpiece is set in reverse mode (counter clockwise).
   i. In some embodiments, if the dental hand piece is not in reverse, the screw shaft may be pushed in and not out as desired.
   j. Optionally the hand piece is set to rotate the head drill at 800 RPM is the recommended revolutions. RPM may be set for example between 200 to 600 RPM and/or between 600 to 900 RPM and/or between 900 to 1200 RPM.
   k. In some embodiments, this will release the screw shaft out of the fixture.

It is expected that during the life of a patent maturing from this application many relevant technologies will be developed and the scope of the terms are intended to include all such new technologies a priori.

As used herein the term “about” refers to ±5%

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween. When multiple ranges are listed for a single variable, a combination of the ranges is also included (for example the ranges from 1 to 2 and/or from 2 to 4 also includes the combined range from 1 to 4).

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A kit for removing a head of a dental implant screw comprising:
head removal tool configured to fit through a dental restoration and remove the head of the dental implant screw.

2. The kit of claim 1, wherein said dental restoration includes an abutment.

3. The kit of claim 1, wherein said head removal tool includes a drill having a diameter greater than a shaft of an implant fixation screw and less than or equal to the head of the screw.

4. The kit of claim 1, wherein said head removal tool includes a drill having a diameter greater than a shaft of an implant fixation screw and less than or equal to the head of said implant fixation screw.

5. The kit of claim 4, wherein the drill has a diameter of between 5/2 to 3 mm.

6. The kit of claim 1, further comprising a drill guide configured to connect to an attachment of a dental implant fixture.

7. The kit of any of claims 1 and 6, wherein the head removal tool is also configured to fit through a dental crown.

8. The kit of claim 6, further comprising: at least one screw shaft removal drill bit.

9. The kit of claim 1, further comprising at least one drill bit for drilling through a shaft of the dental implant screw.

10. A method for removing a seized dental implant screw connecting an abutment to an implant fixture, comprising:
removing a head of the screw from a shaft of the screw;
releasing the abutment from the screw; and
exposing an attachment of the fixture by removing the abutment.

11. The method of claim 10, wherein said removing the head of the screw includes drilling into said head.

12. The method of claim 11, wherein said drilling is performed using a head removal bit which is smaller than or equal to the head of said head of the screw and larger than said shaft of the screw.

13. The method of claim 12, further comprising inserting a distal end of the head removal bit through a hollow of the abutment to contact the head of the screw.

14. The method of claim 13, further comprising attaching the bit to a dental handpiece and using said dental handpiece for rotating the head removal bit.

15. The method of claim 14, wherein a direction of said rotating is counter clockwise.

16. The method of claim 14, further comprising drilling into head of the screw with the head removal bit until the connection between the head of the screw and the shaft of the screw has been severed.

17. The method of claim 16, further comprising ceasing to apply force when the head removal bit has done at least one of separating the head from the shaft of the screw and drilling to a threshold depth.

18. The method of claim 10, further comprising removing the head of the screw from the shaft of the screw.

19. The method of claim 16, further comprising retaining the center axis of the head removal bit is substantially identical to the center axis of the shaft of the dental implant screw during said drilling.

20. The method of claim 17, wherein the threshold depth comprises a depth wherein a thickness of a remaining metal attaching the head to the shaft of the screw is broken by a force applied by handheld gripping tool.

21. The method of claim 16, further comprising
connecting a guide to an attachment of the fixture;
guiding a screw shaft removal tool with said guide while the guide is connected to the attachment.
